(19) United States
(12) Patent Application Publication
(10) Pub. No.: US 2002/0131832 A1
(43) Pub. Date: Sep. 19, 2002

(54) Cutting insert with discrete tip and method for producing the same

(76) Inventor: Gary L. Morsch, Dayton, MN (US)

Correspondence Address: John J. Prizzi, Kennametal Inc., P. O. Box 231, Latrobe, PA, 15650, US

(21) Appl. No.: 09/809,471

(22) Filed: Mar. 15, 2001

(51) Int. Cl. B23B 27/16; B23C 5/20

(52) U.S. Cl. 407/118; 407/119

(57) ABSTRACT

A metal cutting insert incorporates a polycrystalline diamond or a polycrystalline cubic boron nitride material as a pre-formed discrete cutting tip which wraps around the nose of the insert. The insert may further incorporate an integral chipbreaker.

### FIELD OF THE INVENTION

The invention relates generally to cutting inserts and, more particularly to a cutting insert used in metalworking operations incorporating a discrete cutting tip made of a material such as polycrystalline diamond or cubic boron nitride. Additionally, the cutting insert may include a chip breaker.

### BACKGROUND OF THE INVENTION

It is a continuing goal in the metalcutting industry to provide metalcutting inserts with sharp cutting edges that stay sharp longer even when machining non-ferrous and abrasive materials. To this end it has been known to incorporate polycrystalline diamond (PCD) materials and polycrystalline cubic boron nitride (CBN) materials on a carbide substrate to provide an improved cutting edge. U.S. Pat. No. 4,854,784 and U.S. Pat. No. 4,946,319, both assigned to the assignee of the present application and both hereby incorporated by reference, teach a cutting insert having a discrete PCD or CBN cutting tip secured within an existing slot in the insert substrate. However, in the design disclosed in each of these patents, a significant portion of the cutting tip is embedded within the slot and this embedded portion acts only as structural material to retain the tip within the slot and does not contact the workpiece.

Relative to the cost of a typical cemented carbide substrate, the cost of PCD or CBN materials used as a substrate is very high.

An object of this invention is to reduce the amount of PCD or CBN used for such discrete cutting tips, thereby reducing the overall cost of cutting inserts utilizing such tips.

### SUMMARY OF THE INVENTION

In accordance with the subject invention, a cutting insert comprises a polygonal body with a central axis, said body comprising:

a) a top surface and a bottom surface

b) at least two sides and a nose between the top surface and bottom surface,

c) wherein the nose

i) connects two sides and

ii) has a side contour,

e) a recess within the nose, wherein the recess follows the side contour and wherein the recess has a depth and two ends defining a recess length and wherein the depth of the recess anywhere across the length is less than one-half the distance of a line connecting the respective ends at the sides of the body,

f) a pre-formed discrete tip conforming to the shape of, and secured within, the recess, wherein the tip has a top and a front wall that intersect to form a cutting edge.

In yet another embodiment, the cutting insert additionally has a chip breaker adjacent to the land.

### BRIEF DESCRIPTION OF THE DRAWINGS

The above as well as other features and advantages of the invention will become apparent through consideration of the detailed description and connection with the several drawings in which:

FIG. 1 is an exploded isometric view of a cutting insert in accordance with the subject invention;

FIG. 2 is a plan view of the cutting insert illustrated in FIG. 1 in an assembled configuration;

FIG. 3 is a side view of the cutting insert illustrated in FIG. 1 in an assembled configuration;

FIG. 4 is a partial cross-sectional view of the cutting insert illustrated in FIGS. 1-3 taken along arrows 4-4 in FIG. 2;

FIG. 5 and 6 are partial cross-sectional views similar to that illustrated in FIG. 4 but demonstrating different rake angles;

FIG. 7 is an exploded isometric view of a variation of the cutting insert illustrated in FIG. 1 but in a fully assembled configuration.

FIG. 8 is a partial exploded isometric view of a cutting insert having a discrete tip and an associated individual chipbreaker;

FIG. 9 is a partial isometric view of a cutting insert in accordance with an alternate embodiment of the subject invention, whereby the chipbreaker has an undulating shape;

FIG. 10 is a plan view of the insert shown in FIG. 9;

FIG. 11 is a cross sectional view along arrows XI-XI in FIG. 10;

FIG. 12 is a cross-sectional view along arrows XII-XII in FIG. 11;

FIGS. 13-18 are alternate insert configurations to which the subject invention may be applied;

FIG. 19 is an isometric view of a cutting insert in accordance with an alternative embodiment, whereby the discrete cutting tip connects two sides of the insert;

FIG. 20 is a plan view of the insert shown in FIG. 19;

FIG. 21 is a side view of the insert illustrated in FIG. 19;

FIG. 22 is an end view of the cutting insert illustrated in FIG. 19;

FIG. 23 is an isometric view of a cutting insert in accordance with yet another embodiment; and

FIG. 24 is an isometric view of a cutting insert in accordance with yet another embodiment;

FIG. 25 is a plan view of the insert shown in FIG. 24; and

FIG. 26 is a side view of the insert shown in FIG. 24.

### DETAILED DESCRIPTION OF THE INVENTION

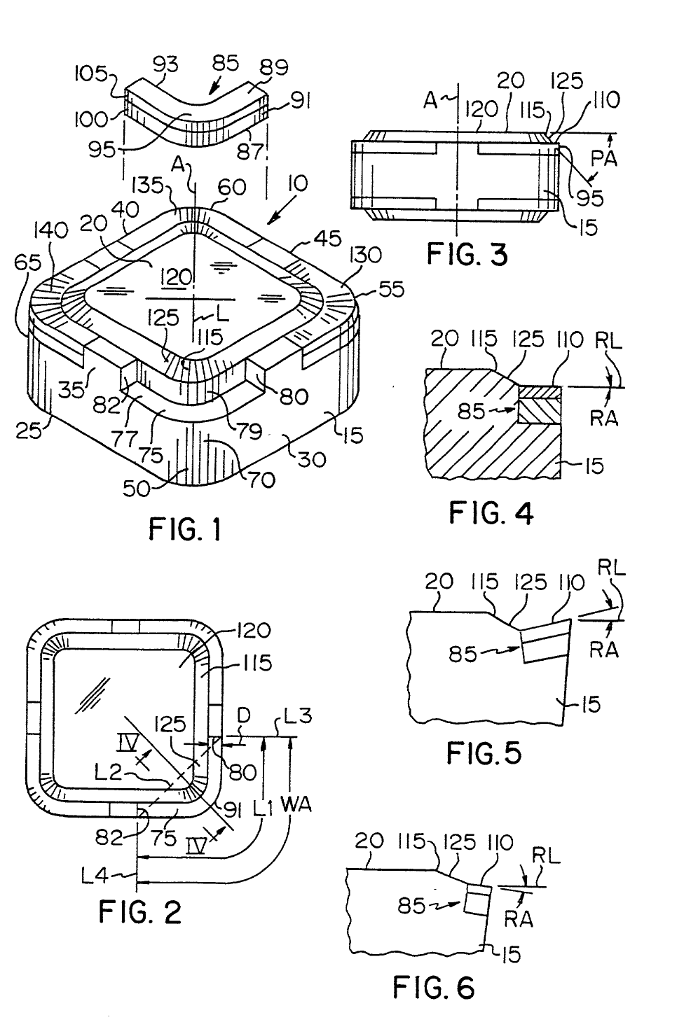

FIG. 1 is a cutting insert 10, having a polygonal body 15, having a central axis A extending therethrough. The body 15 is comprised of a top surface 20 and a bottom surface 25. Between the top surface 20 and the bottom surface 25 are sides 30,35, 40,45. Between each pair of sides is a nose 50,55,60,65 extending between the top surface 20 and the bottom surface 25. A nose 50 may be symmetric about a line L, which is equidistant between the two sides 30,35. The nose 50 has a side contour 70. The nose 50 has a recess 75 which follows the side contour 70. As illustrated in FIG. 1, the recess 75 has a floor 77, a back wall 79, and end walls 80,82.

Directing attention to FIG. 2, the recess 75 has a depth D and a line L1 with a recess length defined by the side contour 70 and the ends 80,82 of the recess 75. The depth D of the recess 75 at any point on the recess 75 is less than one-half the length of a line L2 connecting the respective ends 80,82 at the sides 30,35 of the body 15. The depth D may be less than one-third the length of the line L2 and furthermore, less then one-fourth the length of the line L2.

A pre-formed discrete tip 85 (FIG. 1) has a bottom surface 87 and a top surface 89 with a front wall 91 therebetween, and an opposing back wall 93. The top surface 89 and front wall 91 intersect to form a cutting edge 95.

The body 15 may be comprised of cemented carbide and may be fabricated by molding such that the recess 75 is molded into the insert body 15. In the alternative, the recess 75 may be generated after the insert body 15 is fabricated by any number of commercial techniques for grinding or removing material from a cemented carbide substrate.

The tip 85 may be comprised of a support layer 100, and a cutting layer 105 deposited upon the support layer 100. The cutting layer 105 may be comprised of PCD, which is a common material typically used for non-ferrous applications or, in the alternative, may be comprised of CBN which is a common material used for hardened non-ferrous application.

The support layer 100 of the tip 85 may be comprised of cemented carbide. Additionally, the insert body 15 may be comprised of cemented carbide and manufactured in any number of conventional processes known in the art. However, at least one embodiment of the subject invention is directed to a substrate manufactured by molding.

The tip 85 may be secured within the recess 75 by brazing the support layer 100 of the tip 85 within the recess 75.

Again directing attention to FIG. 2, lines L3 and L4 extend perpendicular from the front wall 91 at each end 80,82 and form a wraparound angle WA of not greater than 180 degrees.

Directing attention to FIG. 4, the tip 85 may have a land 110, which defines a rake angle RA with a line RL parallel to the top 20 of the insert body 15. As illustrated in FIGS. 4-6, the land 110 may define a rake angle RA with a line RL parallel to the top 20 of the insert body 15 of between minus 15 degrees and plus 25 degrees.

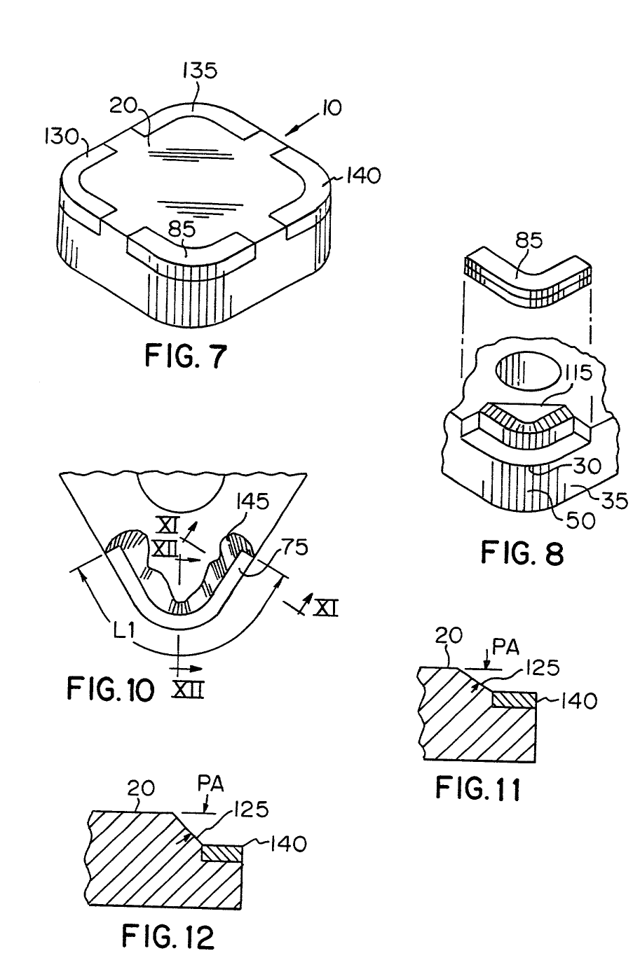

FIG. 7 illustrates an isometric view of the cutting insert 10 in FIG. 1 in an assembled configuration and without the chipbreaker 115.

The discussion so far has been directed to a cutting insert without a chipbreaker. Although it is entirely possible to fabricate an insert in accordance with the subject invention without a chipbreaker, it is also possible to include a chipbreaker with the current design.

Briefly returning to FIG. 1, the cutting insert 10 may include a chipbreaker 115 having a top 120 and a contact wall 125. Although as illustrated in FIG. 1-6 the top 20 of the insert is identical to the top 120 of the chipbreaker 115, it is entirely possible for the chipbreaker to be selectively placed only in the region of the nose 50,55,60,65 to which it is associated. This feature is illustrated in the exploded isometric view of FIG. 8. Additionally, while a single cutting tip 85 has been discussed with respect to a single nose 50, it should be appreciated that a cutting tip 130,135,140 may be associated with noses 55,60,65, respectively as shown in FIG. 1.

Directing attention to FIG. 3, the chipbreaker contact wall 125 is positioned adjacent to the land 110, and away from the cutting edge 95. The contour of the chipbreaker wall 125 may be similar to that of the nose 50 in that it is symmetric about the line L equidistant distant between the two sides 30,35 (FIG. 2). Although the form of the chipbreaker wall 125 may be any of a variety of forms known in the art to promote the formation of chips, FIGS. 2 and 3 illustrate a preferred embodiment in which the chipbreaker contact wall 125 has a constant profile angle PA relative to the top 20 of the insert body 15 over the length L1 adjacent to the cutting tip 85. In particular, the profile angle PA may have a range between 5-45 degrees.

The depth of the land 110, between the cutting edge 95 and the contact wall 125, may be the same as the depth D of the recess 75. Additionally, the contact wall 125 extends above the level of the cutting edge 95.

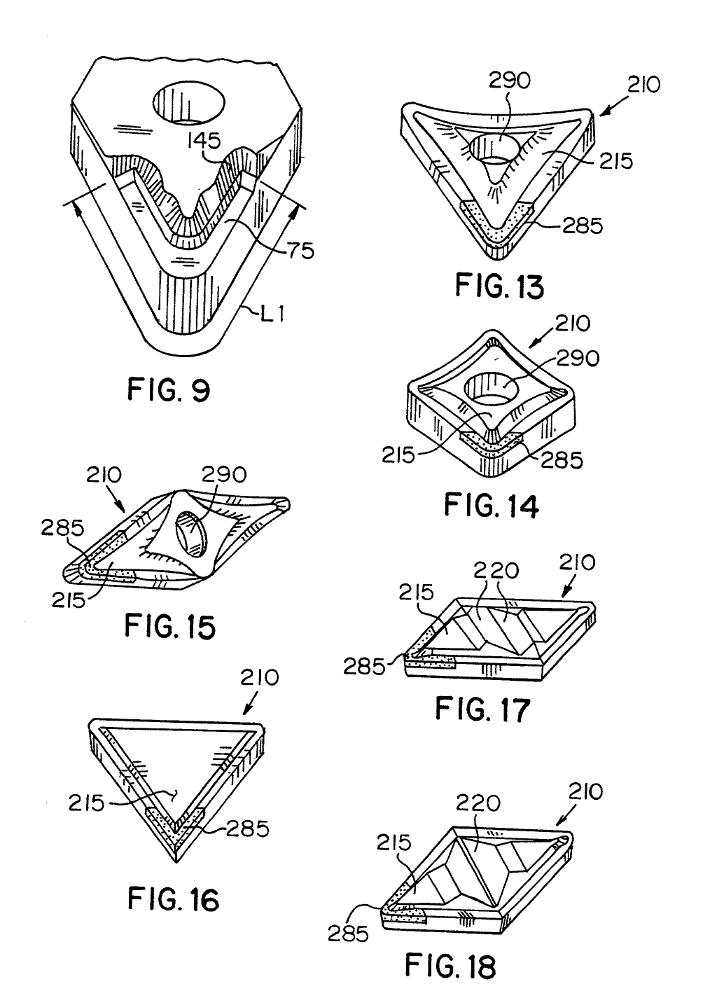

FIG. 3 illustrates a chipbreaker wall 125 having a constant profile angle PA. Directing attention to FIG. 9, a chipbreaker wall 125 has an undulating profile such that the profile angle PA, defined in FIG. 3, varies along the recess length L1 of the line L1 along the recess 75. FIG. 10 is a plan view of the isometric view shown in FIG. 9, and sections XI-XI and XII-XII illustrated in FIGS. 11 and 12 respectively indicate the manner in which the profile angle PA varies along the recess length L1 of the cutting tip 140. The profile angle PA may have a value ranging between 5-45 degrees. When the profile angle PA is constant over the length L of the chipbreaker wall 125, the angle PA may have a value between 5-45 degrees, while when the profile angle varies over the length L of the chipbreaker wall 125, the profile angle may have a value of between 5-45 degrees for the portion of the profile having the smallest angle and between 15-45 degrees for the portion of the chipbreaker wall 145 having the greatest profile angle.

As previously mentioned, the profile of the chipbreaker wall does not necessarily require a constant profile angle or an undulating profile and it should be understood that a variety of other chipbreaker walls are available and known to those skilled in the art.

A method of fabricating a cutting insert having a discrete cutting tip and having a polygonal body with a central axis and a top surface and a bottom surface with at least two sides and a nose between the top surface and bottom surfaces and a nose connecting the two sides, wherein the nose is symmetric about a line equidistant between the two sides, wherein the method comprises the steps of:

a) forming the polygonal body with a recess within the nose following the side contour of the nose, wherein the recess has a depth and two ends defining a length and wherein the depth of the recess anywhere across the length is less than one half the distance of a line connecting the respective ends at the sides of the body,

b) positioning a pre-formed discrete tip conforming to the shape of the recess within the recess, wherein the tip has a top and a front wall that intersect to form a cutting edge and

c) securing the tip within the recess.

What has been discussed so far is a cutting insert 10 having a square shape, and a cutting tip 85 is secured to a corner recess 75 in one nose 50. It should be appreciated that such a cutting tip 85 may exist in recesses in any of the other noses 55,60,65. Just as before, the depth D may be less than one-third the length of the line L2 and furthermore, less than one-fourth the length of the line L2.

The subject invention should not be limited to a cutting insert 10 having a square shape. In particular. FIGS. 13-18 show a variety of applications of the present invention and inserts of various configurations. In these several figures, each insert is generally indicated by the reference character 210 and the cutting tip is indicated by the reference character 285 while the chipbreaker is indicated generally by the reference character 215. However, just as before, it should be appreciated that the subject may or may not include a chipbreaker.

FIG. 13 shows the use of a cutting tip 285 with a triangle metal cutting insert having the chipbreaker 215. FIG. 14 shows the use of this invention with a rectangular insert with a chipbreaker 215. It should be noted that each of the inserts of FIGS. 13, 14 and 15 have a centrally disposed hole 290 therein which can be used by a securing means for retaining the insert onto a tool holder. FIG. 15 shows a similarly configured diamond shaped insert with a chipbreaker 215.

FIGS. 16-18 show another embodiment of the present invention in which the metal insert body does not include a hole therein for securing a metal cutting insert to a tool. Rather, the metal cutting insert is retained in the tool by a clamping mechanism, which securely retains the insert within the tool. Additionally, the inserts illustrated in FIGS. 17 and 18 incorporate a pair of integral notches 220, which are engaged by a clamping arrangement such as that taught in U.S. Pat. No. 3,754,309 which is assigned to the assignee of the present invention and which is incorporated herein by reference. In all other respects, however, the inserts 210 shown in FIGS. 16-18 incorporate the chipbreaker 215 in combination with the cutting tip 285.

What has so far been described are cutting inserts having two sides which converge to define a nose. However, it is entirely possible for the two sides to be parallel and act as a bridge between these two sides, thereby providing a recess to accept a cutting tip.

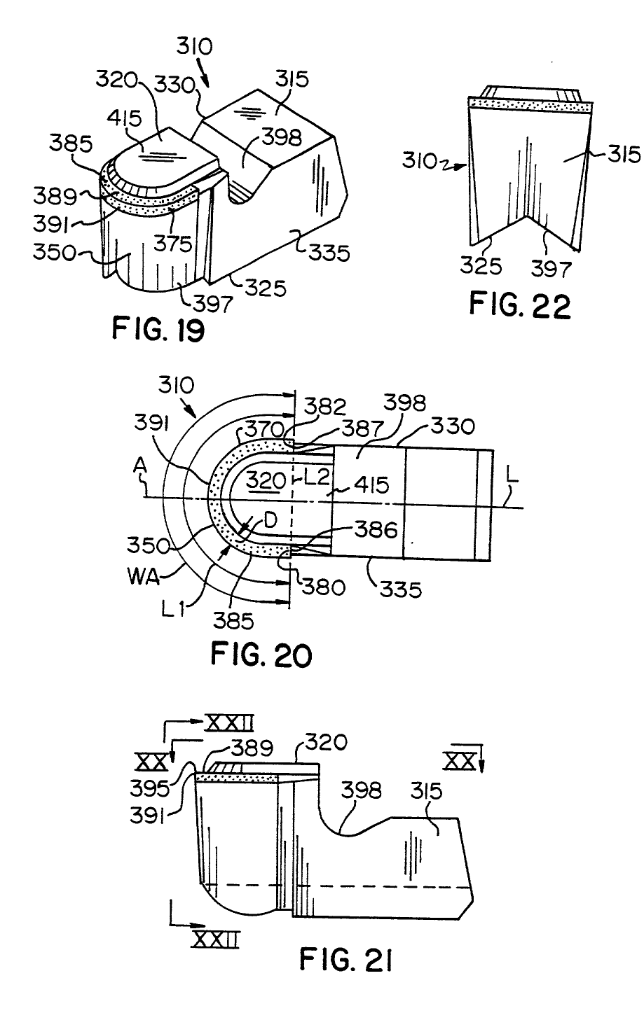

FIGS. 19-22 disclose an insert similar to that disclosed in U.S. Pat. No. 4,946,319, which is assigned to the assignee of the present invention and is hereby incorporated by reference. In particular, FIGS. 19-22 illustrate a cutting insert 310, comprised of a polygonal body 315 with a central axis A. The body 315 is comprised of a top surface 320 and bottom surface 325. At least two side surfaces 330,335 and a nose 350 extend between the top surface 320 and bottom surface 325. The nose 350 connects the two sides 330,335 and is symmetric about a line L equidistant distant between the two sides 330,335. In this embodiment, the line L is superimposed over the central axis A. Additionally, the nose 350 has a side contour 370. The body 315 further has a recess 375 within the nose 350 wherein the recess 375 follows the side contour 370. Furthermore, the recess 375 has a depth D and two ends 380,382 defining a length L1. The depth D of the recess 375 anywhere along the length L1 is less then one-half the distance of a line L2 connecting the respective ends 380,382 at the sides 330,335 of the body 315. A pre-formed discrete tip 385 conforms to the shape of and is secured within the recess 375. The tip 385 has a top surface 389, and a front wall 391 that intersect to form a cutting edge 395. The depth D may be less than one-third the length of the line L2 and furthermore, less than one-fourth the length of the line L2.

Just as before, the body 315 may be fabricated by molding and the recess 375 may be imparted to the insert body 315 during such molding. In the alternative, the recess 375 may be generated after the insert body 315 is fabricated. With respect to the composition of the tip 385, the previous discussion directed to tip 85 may be applied.

The tip 385 may be secured within the recess 375 by brazing.

The tip 385 has a first end 386, a second end 387, and a front wall 391. Lines extending perpendicular from the outer side of each end 386,387 intersect to form a wraparound angle WA of not greater than 180 degrees. As illustrated in FIG. 20 the wraparound angle WA is approximately 180 degrees. Furthermore, as illustrated in FIG. 19 and in FIG. 20, the tip 385 is U-shaped. The insert 315 further has a chipbreaker 415.

The insert 310 has a mounting surface 397 and a clamping surface 398. The mounting surface 397 rests within a conforming pocket in a toolholder, while a toolholder clamp contacts the clamping surface 398 to urge the insert 310 within the pocket.

The method for producing such an insert comprises the steps of forming the polygonal body 15, with a recess 75 within the nose 50 following the side contour 70 of the nose 50. The recess 75 has a depth D and two ends 80,82 defining length L. The depth D of the recess 75 at any point across the length is less than one-half the distance of a line L1 connecting the respective ends 80,82 at the sides 30,35 of the body 15. The method further comprises the steps of positioning a pre-formed discrete tip 85 conforming to the shape of the recess 75 within the recess 75. The tip 85 has a top surface 89 and a front wall 91 that intersect to form a cutting edge 95. Finally, the tip 85 is secured within the recess 75.

The step of forming the polygonal body 15 is further comprised of molding the body 15 and including the recess 75 within the mold. The step of forming the polygonal body 15 may also be comprised of molding the polygonal body 15 and then separately removing material to form the recess 75.

The step of forming the polygonal body 15 may further include forming a chipbreaker 115 on the insert body 15. The step of securing the tip 85 within the recess 75 may be comprised of brazing the tip 85 within the recess 75.

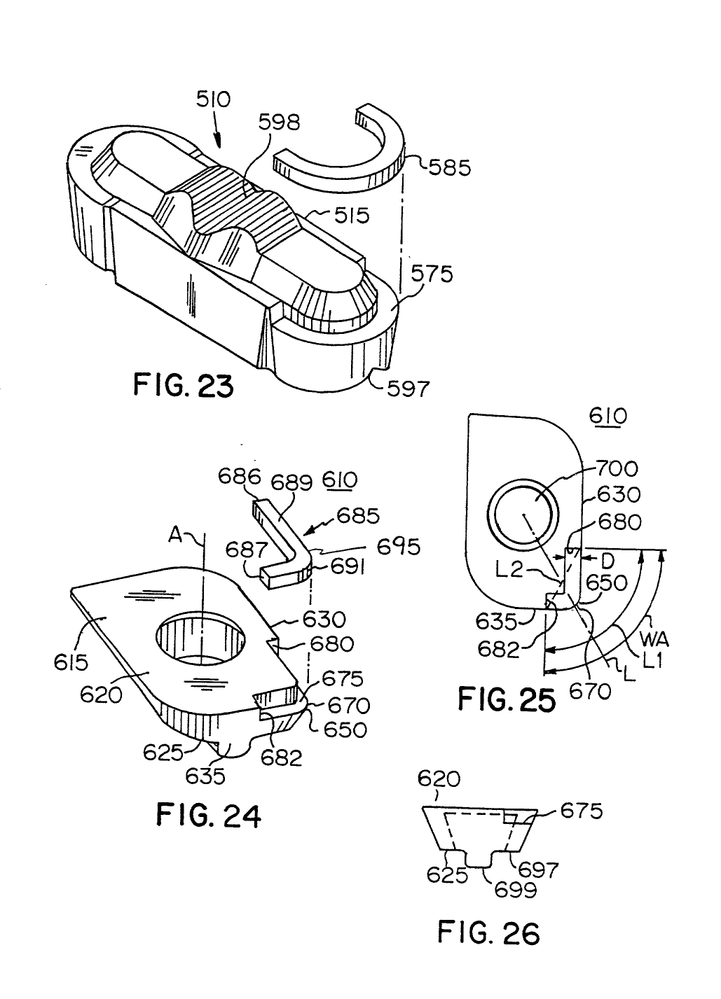

FIG. 23 shows yet another insert embodiment whereby an insert 510 has an insert body 515 with a recess 575 to accommodate a U-shaped tip 585. The subject insert has a mounting surface 597 and a clamping surface 598 that may be secured within a tool holder in a manner similar to that of the insert described in FIGS. 19-22.

What has so far been described are cutting inserts having a nose which connects two sides, and is symmetric about a line equidistant between the two sides. It is also possible for the nose to connect two sides and to be asymmetric about a line equidistant between the two sides.

FIGS. 24-26 disclose an insert having such features. In particular, FIGS. 24-26 illustrate a cutting insert 610 comprised of a body 615, with a central axis A. The body 615 is comprised of top surface 620, and bottom surface 625. At least two side surfaces 630, 635 and a nose 650 extend between the top surface 620 and bottom surface 625. The nose 650 connects the two sides 630, 635 and is located about a line L, between the two sides 630, 635. Additionally, the nose 650 has a side contour 670. The body 615 further has a recess 675, which follows the side contour 670. Furthermore, the recess 675 has a depth D and two ends 680, 682 defining a length L1. The depth D of recess 675 anywhere along the length Li is less than one-half the distance of a line L2, connecting the respective ends 680, 682 at the sides 630, 635 of the body 615. A pre-formed discrete tip 685, conforms to the shape of, and is secured within the recess 675. The tip 685 has a top surface 689, and a front wall 691 that intersect to form a cutting edge 695. The depth D may be less than one-third the length of the line L2 and furthermore, less than one-fourth the length of the line L2.

Just as before the body 615 may be fabricated by molding and the recess 675 may be imparted to the insert body 615 during such molding. In the alternative, the recess 675 may be generated after the insert body 615 is fabricated. With respect to the composition of the tip 685, the previous discussion directed to tip 685 may be applied.

The tip 685 may be secured within the recess 675 by brazing. The tip 685 has the first end 686, a second end 687, and a front wall 691. Lines extending perpendicular from the outer side of each end 686, 687 intersect to form a wrap-around angle (WA) of not greater than 180 degrees. Furthermore, the insert 615, may have a chip breaker, similar to that illustrated in the previous embodiments of this invention.

The insert 610, has a mounting surface 697, comprised of the bottom surface 625, and a rail 699 which may fit within mating groove in a conforming pocket in a toolholder. As illustrated, a bore 700 extending through the insert body 615 may accept a mounting screw which is threadably engaged within a toolholder body to secure the insert body 615 within the pocket of the toolholder. However, it should be appreciated that the insert 610 may not have a bore 700, but may have a continuous top surface suitable for the application of a clamp against the insert 610, thereby holding the insert within a conforming pocket of the toolholder.

The method for producing such an insert is similar to the method previously described further embodiments.

Throughout this discussion, inserts having a variety of shapes and configurations for holding such inserts have been presented. It should be appreciated any shape of insert may be secured within a toolholder, using any of a number of different configurations, whether it be a hold down screw extending into a bore through the insert body and threaded into the toolholder pocket, or a clamp holding the insert within the pocket of a toolholder. Therefore, the manner of holding inserts, and the modifications to an insert body necessary for such holding discussed in this application should not be interpreted as a limitation upon the scope of the subject inventor.

It is thought the present invention and many of its intended advantages will be understood from the foregoing description and that it will be apparent that various changes may be made in the form construction an arrangement of the parts thereof, without departing from the spirit and scope of the invention, or sacrificing all of its material advantages, the form herein before described merely preferred or exemplary embodiments thereof.

What is claimed is:

1. A cutting insert comprising a polygonal body with a central axis, said body comprising:
a) a top surface and a bottom surface
b) at least two sides and a nose between the top surface and bottom surface,
c) wherein the nose
i) connects two sides, and
ii) has a side contour,
d) a recess within the nose, wherein the recess follows the side contour and wherein the recess has a depth and two ends defining a recess length and wherein the depth of the recess anywhere across the length is less than one half the distance of a line connecting the respective ends at the sides of the body,
e) a pre-formed discrete tip conforming to the shape of, and secured within, the recess, wherein the tip has a top and a front wall that intersect to form a cutting edge.

2. The cutting insert according to claim 1 wherein the body is fabricated by molding and the recess is imparted to the insert during such molding.

3. The cutting insert according to claim 1 wherein the recess is generated after the insert body is fabricated.

4. The cutting insert according to claim 1 wherein the tip is comprised of a support layer and a cutting layer deposited upon the support layer.

5. The cutting insert according to claim 4 wherein the cutting layer is comprised of one from the group of polycrystalline diamond and cubic boron nitride and wherein the cutting layer is bonded to the support layer.

6. The cutting insert according to claim 4 wherein the support layer is comprised of cemented carbide.

7. The cutting insert according to claim 6 wherein the insert body is comprised of cemented carbide.

8. The cutting insert according to claim 7 wherein the tip is secured within the recess by brazing.

9. The cutting insert according to claim 1 wherein tip has a first end, a second end and an outer side, and wherein lines extending perpendicular from the outer side at each end intersect to form a wraparound angle of not greater than 180 degrees.

10. The cutting insert according to claim 1 wherein the tip is U-shaped.

11. The cutting insert according to claim 1 wherein the tip has a land and wherein the land defines a rake angle with a line parallel to the top of the insert body of between −15° to +25°.

12. The cutting insert according to claim 11 further including a chip breaker having a top and a contact wall, wherein the contact wall is positioned adjacent to the land and away from the cutting edge.

13. The cutting insert according to claim 12 wherein the contact wall is symmetric about a line equidistant between the two sides.

14. The cutting insert according to claim 12 wherein the width of the land between the cutting edge and the contact wall is equidistant over the length of the cutting edge.

15. The cutting insert according to claim 12 wherein the contact wall extends above the cutting edge.

16. The cutting insert according to claim 12 wherein the contact wall has a constant profile angle relative to the top of the insert body over the length of the wall adjacent to the cutting tip.

17. The cutting insert according to claim 16 wherein the profile angle may have a value between 5-45 degrees.

18. The cutting insert according to claim 12 wherein the contact wall has an undulating profile along the length of the wall adjacent to the cutting tip.

19. The cutting insert according to claim 18 wherein the undulating profile has a minimum profile angle of 5 degrees and a maximum profile angle of 45 degrees.

20. The cutting insert according to claim 12 wherein the contact wall extends over the entire perimeter of the cutting insert body.

21. The cutting insert according to claim 12 wherein the contact wall is isolated to the region of the cutting edges.

22. The cutting insert according to claim 1, wherein the nose is symmetric about a line equidistant between the two sides.

23. The cutting insert according to claim 1 wherein the nose is asymmetric about a line equidistant between the two sides.

24. The cutting insert according to claim 1 wherein a depth of the recess anywhere across the length is less than one-third the distance of a line connecting the respective ends at the sides of the body.

25. The cutting insert according to claim 1 wherein a depth of the recess anywhere across the length is less than one-fourth the distance of a line connecting the respective ends at the sides of the body.

26. A method of fabricating a cutting insert having a discrete cutting tip and having a polygonal body with a central axis and a top surface and a bottom surface with at least two sides and a nose between the top surface and bottom surfaces and a nose connecting the two sides, wherein the method comprises the steps of:
a) forming the polygonal body with a recess within the nose following the side contour of the nose, wherein the recess has a depth and two ends defining a recess length and wherein the depth of the recess anywhere across the length is less than one half the distance of a line connecting the respective ends at the sides of the body,
b) positioning a pre-formed discrete tip conforming to the shape of the recess within the recess, wherein the tip has a top and a front wall that intersect to form a cutting edge and
c) securing the tip within the recess.

27. The method according to claim 26 wherein the step of forming the polygonal body is comprised of molding the body and including the recess within the mold.

28. The method according to claim 26 wherein the step of forming the polygonal body is comprised of molding the polygonal body and then separately removing material to form the recess.

29. The method according to claim 26 wherein the step of forming the polygonal body further includes forming a chip breaker on the insert body.

30. The method according to claim 26 wherein the step of securing the tip within the recess is comprised of brazing the tip within the recess.

31. The method according to claim 26, wherein the nose is symmetric about a line equidistant between the sides.

32. The method according to claim 26, wherein the nose is asymmetric about a line equidistant between the sides.

33. The method according to claim 26 wherein the depth of the recess anywhere across the length is less than one-third the distance of a line connecting the respective ends at the sides of the body.

34. The method according to claim 26 wherein the depth of the recess anywhere across the length is less than one-fourth the distance of a line connecting the respective ends at the sides of the body.
